(19) United States
(12) Patent Application Publication
(10) Pub. No.: US 2010/0286902 A1
(43) Pub. Date: Nov. 11, 2010

(54) NAVIGATION ROUTE DETERMINING METHOD AND RELATED APPARATUS

(76) Inventor: Tao Zhang, Hefei (CN)

Correspondence Address: NORTH AMERICA INTELLECTUAL PROPERTY CORPORATION, P.O. BOX 506, MERRIFIELD, VA, 22116, US

(21) Appl. No.: 12/489,414

(22) Filed: Jun. 22, 2009

(30) Foreign Application Priority Data
May 8, 2009 (CN) 200910138579.7

(51) Int. Cl. G01C 21/36

(52) U.S. Cl. 701/200

(57) ABSTRACT

A navigation route determining method for planning a target navigation route from a specific start point to a specific end point, includes: determining a plurality of candidate navigation routes, wherein each of the candidate navigation routes is from the specific start point to the specific end point; estimating a plurality of expenses corresponding to the plurality of candidate navigation routes, respectively; and selecting one of the plurality of candidate navigation routes as the target navigation route according the plurality of expenses.

### BACKGROUND

The present invention relates to a navigation route determining method and related apparatus, and more particularly to a method for determining a navigation route with an estimated expense and related apparatus.

A navigator such as a Global Positioning System (GPS) has become more and more popular in recent years. The navigator installed in a vehicle has the purpose of navigating the vehicle from a starting point to a destination. To provide more information for a user of the navigator, the navigator is usually a multifunctional device. For the example, the navigator not only shows the navigating route from the starting point to the destination, some navigators also have the function of showing information, such as the name of a building, along the navigating route. Therefore, the information of the toll stations along the navigating route can also be shown by some navigators. Conventionally, to reduce the expense of a driver, a conventional navigator can be set up to avoid all of the toll stations along the navigating route when setting the navigating route. However, avoiding the toll stations can be an ineffective way to reduce the expense of the driver since the route without the toll stations may be much longer than the route with the toll stations, and consequently the driver may spend more money on fuel expense than paying the toll fees. Therefore, providing an efficient and convenient method for estimating the expense of the driver by following the navigating route is a significant concern in the field of Global Positioning System.

### SUMMARY OF THE INVENTION

One of the objectives of the present invention is to provide a method for determining a navigation route with an estimated expense and related apparatus.

According to a first embodiment of the present invention, a navigation route determining method for planning a target navigation route from a specific start point to a specific end point is disclosed. The navigation route determining method comprises: determining a plurality of candidate navigation routes, wherein each of the candidate navigation routes is from the specific start point to the specific end point; estimating a plurality of expenses corresponding to the plurality of candidate navigation routes, respectively; and selecting one of the plurality of candidate navigation routes as the target navigation route according the plurality of expenses.

According to a second embodiment of the present invention, a navigation route determining method for planning a target navigation route from a specific start point to a specific end point is disclosed. The navigation route determining method comprises: determining a fuel consuming rate of a vehicle; and determining the target navigation route according to at least the fuel consuming rate.

According to a third embodiment of the present invention, a navigation route determining apparatus for planning a target navigation route from a specific start point to a specific end point is disclosed. The navigation route determining apparatus comprises a navigation route planning module, a computing module, and an interfacing module. The navigation route planning module determines a plurality of candidate navigation routes, wherein each of the candidate navigation routes is from the specific start point to the specific end point. The computing module is coupled to the navigation route planning module for estimating a plurality of expenses corresponding to the plurality of candidate navigation routes, respectively. The interfacing module is coupled to the computing module for selecting one of the plurality of candidate navigation routes as the target navigation route according the plurality of expenses.

According to a fourth embodiment of the present invention, a navigation route determining apparatus for planning a target navigation route from a specific start point to a specific end point is disclosed. The navigation route determining apparatus comprises a detecting module and a navigation route planning module. The detecting module determines a fuel consuming rate of a vehicle. The navigation route planning module is coupled to the detecting module for determining the target navigation route according to at least the fuel consuming rate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a navigation route determining method for planning a target navigation route from a specific start point to a specific end point according to an embodiment of the present invention.

FIG. 2 is a diagram illustrating a navigation route determining apparatus according to a second embodiment of the present invention.

FIG. 3 is a diagram illustrating a process of planning the target navigation route according to the navigation route determining method of the present invention.

FIG. 4 is a diagram illustrating the navigation route display of the target navigation route according to a second embodiment of the present invention.

FIG. 5 is a diagram illustrating the navigation route display of the target navigation route according to a third embodiment of the present invention.

FIG. 6 is a diagram illustrating the navigation route display of the target navigation route according to a fourth embodiment of the present invention.

FIG. 7 is a diagram illustrating the computing module of the navigation route determining apparatus as shown in the FIG. 2 of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

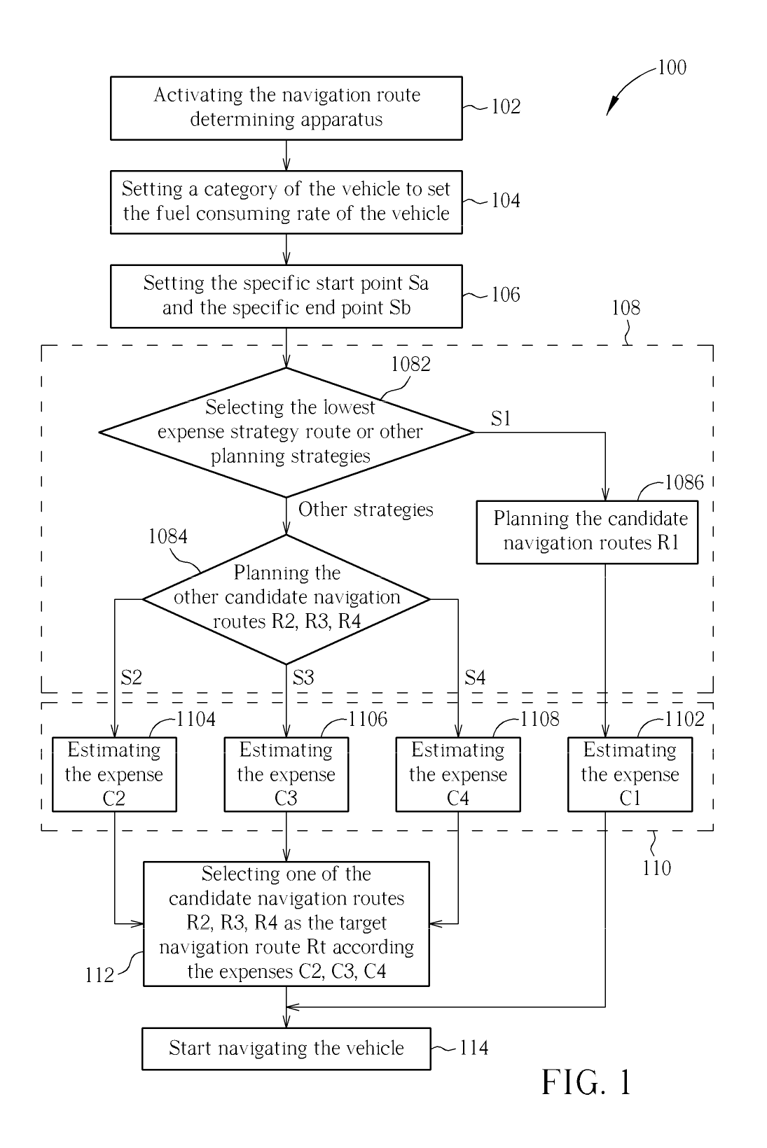

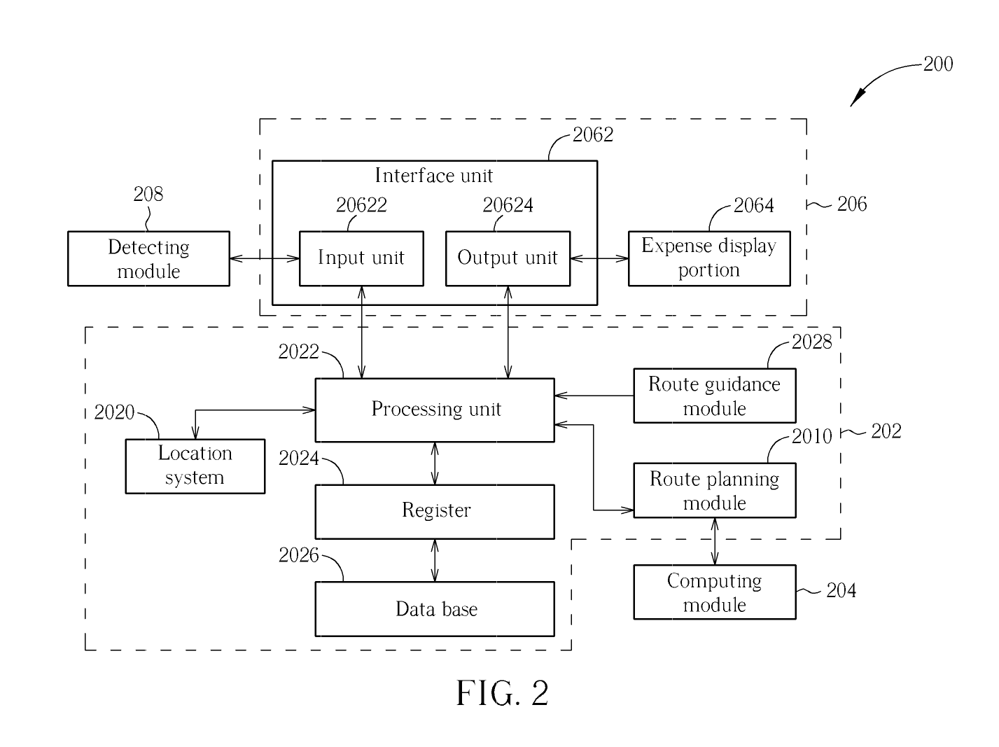

Please refer to FIG. 1. FIG. 1 is a flowchart illustrating a navigation route determining method 100 for planning a target navigation route Rt from a specific start point to a specific end point according to an embodiment of the present invention. Provided that substantially the same result is achieved, the steps of the flowchart shown in FIG. 1 need not be in the exact order shown and need not be contiguous, that is, other steps can be intermediate. Please refer to FIG. 2. FIG. 2 is a diagram illustrating a navigation route determining apparatus 200 according to a second embodiment of the present invention, in which the navigation route determining apparatus 200 is utilized to perform the operations of navigation route determining method 100. Please note that, the navigation route determining apparatus 200 is installed in a vehicle. The navigation route determining method 100 comprises the following steps:

Step 102: activating the navigation route determining apparatus 200;

Step 104: setting a category of the vehicle to set the fuel consuming rate of the vehicle;

Step 106: setting the specific start point Sa and the specific end point Sb;

Step 108: determining a plurality of candidate navigation routes R1, R2, R3, R4 according to a plurality of route planning strategies S1, S2, S3, S4 respectively, wherein each of the candidate navigation routes R1, R2, R3, R4 is from the specific start point Sa to the specific end point Sb;

Step 110: estimating a plurality of expenses C1, C2, C3, C4 corresponding to the plurality of candidate navigation routes R1, R2, R3, R4, respectively;

Step 112: selecting one of the plurality of candidate navigation routes R1, R2, R3, R4 as the target navigation route Rt according the plurality of expenses C1, C2, C3, C4;

Step 114: start navigating the vehicle.

In this embodiment, the plurality of expenses C1, C2, C3, C4 are obtained according to the fuel consuming rate of the vehicle and a total toll expense Ct of the plurality of candidate navigation routes R1, R2, R3, R4 respectively. However, this is not meant to be a limitation of the present invention. In other words, in another embodiment of the present invention, the plurality of expenses C1, C2, C3, C4 are obtained according to only the fuel consuming rate of the vehicle or only a total toll expense of the plurality of candidate navigation routes R1, R2, R3, R4 respectively. In step 106, when the specific start point Sa and the specific end point Sb are set, the plurality of candidate navigation routes R1, R2, R3, R4 are planned by the navigation route determining apparatus 200 according to the plurality of route planning strategies S1, S2, S3, S4 respectively. Please note that, the present invention is not limited in the above-mentioned four candidate navigation routes or four route planning strategies. In this embodiment, the route planning strategy S1 is the lowest expense strategy from the specific start point Sa to the specific end point Sb, the route planning strategy S2 is the shortest traveling time strategy from the specific start point Sa to the specific end point Sb, the route planning strategy S3 is the strategy without passing the toll stations from the specific start point Sa to the specific end point Sb, and the route planning strategy S4 is the shortest distance strategy from the specific start point Sa to the specific end point Sb. Furthermore, in this embodiment, the step 108 is divided into two sub-steps, which are step 1082 and step 1084, to categorize the above-mentioned route planning strategies S1, S2, S3, S4. In step 1082, the lowest expense strategy, i.e., the route planning strategy S1, can be directly selected and goes to the next step, which is the step 1086; otherwise, it goes to step 1084 to choose one of the other route planning strategies S2, S3, S4. In step 1086, the candidate navigation routes R1 are planned out. On the other hand, in step 1084, the other candidate navigation routes R2, R3, R4 are planned out. The main purpose of this mechanism is to provide a fast and efficient way for the user to select the lowest expense strategy.

In step 110, the plurality of expenses C1, C2, C3, C4 corresponding to the plurality of candidate navigation routes R1, R2, R3, R4, respectively are estimated. Please note that, this is not meant to be the limitation of the present invention. In other words, to increase the efficiency of the navigation route determining apparatus 200, when the lowest expense strategy, i.e., the route planning strategy S1, is selected in step 1082, only the expense C1 is calculated (i.e., step 1102); otherwise, the other expenses C2, C3, C4 are calculated as shown in FIG. 1.

Furthermore, to calculate each expense of each candidate navigation route, such as the candidate navigation route R1, the navigation route determining apparatus 200 determines a distance of the candidate navigation route R1, and then estimates a total fuel expense Cf of the candidate navigation route R1 according to the distance and the fuel consuming rate (i.e., liter/100 km) of the vehicle. Then, the navigation route determining apparatus 200 determines the total toll expense Ct corresponding to the candidate navigation route R1. When the total fuel expense Cf and the total toll expense Ct are obtained, the navigation route determining apparatus 200 sum up the total fuel expense Cf and the total toll expense Ct to become the expense C1 of the candidate navigation route R1.

More specifically, in estimating the total fuel expense Cf, it is assumed that the candidate navigation route R1 comprises a plurality of road segments R1_1˜R1_n. Then, for each road segment, such as the road segment R1_1, the navigation route determining apparatus 200 determines a distance of the road segment R1_1, and estimates the fuel expense of the road segment R1_1 according to the distance of the road segment R1_1, the fuel consuming rate of the vehicle, and a category of the road segment (e.g., a highway or a byway). When the fuel expenses of all of the road segments R1_1˜R1_n are determined, the navigation route determining apparatus 200 sums up all the fuel expenses of the road segments R1_1˜R1_n to determine the total fuel expense Cf of the candidate navigation route R1. In this embodiment, when the expense C1 of the candidate navigation route R1 is generated, the navigation route determining apparatus 200 selects the candidate navigation route R1 as the target navigation route Rt to start navigating the vehicle (step 114).

Accordingly, the expense C1 of the candidate navigation route R1 can be expressed by the following equation (1):

C1=Cf+Ct. (1)

In this embodiment, the total fuel expense Cf can be calculated according to the categories of the road segments of the candidate navigation route R1, which are a highway and a byway. Therefore, the total fuel expense Cf can be expressed by the following equation (2):

Cf=X+Y, (2)

wherein X is the fuel expense of the road segments of the byway and Y is the fuel expense of the road segments of the highway, and X can be expressed by the following equation (3):

X=A*B*110%/100*D, (3)

wherein A is the fuel expense per 100 kilometer (km) of the vehicle, i.e., liter/100 km, B is the cost per liter of the fuel, i.e., $/liter, and D is the total length of the road segments of the byway in units of kilometers. Please note that, the equation (3) is further multiplied by a factor of (110%/100), which is aimed to simulate the fact of the higher fuel consumption of the vehicle when driving on the byway. On the other hand, Y can be expressed by the following equation (4):

Y=A*B*90%/100*E, (4)

wherein A is the fuel expense per 100 kilometer (km) of the vehicle, B is the cost per liter of the fuel, and E is the total length of the road segments of the highway in units of kilometers. Similarly, the equation (4) is further multiplied by a factor of (90%/100), which is aimed to simulate the fact of the lower fuel consumption of the vehicle when driving on the highway.

In addition, the total toll expense Ct can be expressed by the following equation (5):

Ct=G+H, (5)

wherein G is the total toll fee paid to the toll(s) that charge a predetermined toll fee Cp on the candidate navigation route R1, and H is the total toll fee paid to the toll(s) that charge the toll fee according to the traveling distance of the vehicle on the candidate navigation route R1. Therefore, G can be expressed by the following equation (6):

G=CP*N, (6)

wherein N is the total number of the tolls that charge the predetermined toll fee Cp on the candidate navigation route R1. Furthermore, H can be expressed by the following equation (7):

$$H = {\sum }_{u} {Ck}_{u} * {M}_{u} , \qquad ( 7 )$$

wherein Ck is the charge per kilometer on the highway, M is the traveling distance of the vehicle, u represents the u^{th} toll on the candidate navigation route R1, and u can be any non-negative integer number. Therefore, Ckᵤ is the charge per kilometer of the u^{th} toll, and Mᵤ is the traveling distance of the vehicle by the u^{th} toll. Please note that, the above-mentioned A and B can be set manually or automatically in step 104.

On the other hand, if the step 1084 is selected previously, the expenses C2, C3, C4 corresponding to the candidate navigation routes R2, R3, R4 are generated in step 1104, 1106, 1108, respectively. Then, in step 112, a user of the navigation route determining apparatus 200 can select one of the plurality of candidate navigation routes R2, R3, R4 as the target navigation route Rt according the plurality of expenses C2, C3, C4 to start navigating the vehicle (step 114).

Please note that, the present invention does not limit the way to set the category of the vehicle in step 104. In other words, in another embodiment of the present invention, the navigation route determining apparatus 200 automatically detects the category of the vehicle to set the fuel consuming rate of the vehicle, or in another embodiment of the present invention, the category of the vehicle is manually selected from a plurality of predetermined vehicle categories to set the fuel consuming rate of the vehicle, which also being the scope of the present invention.

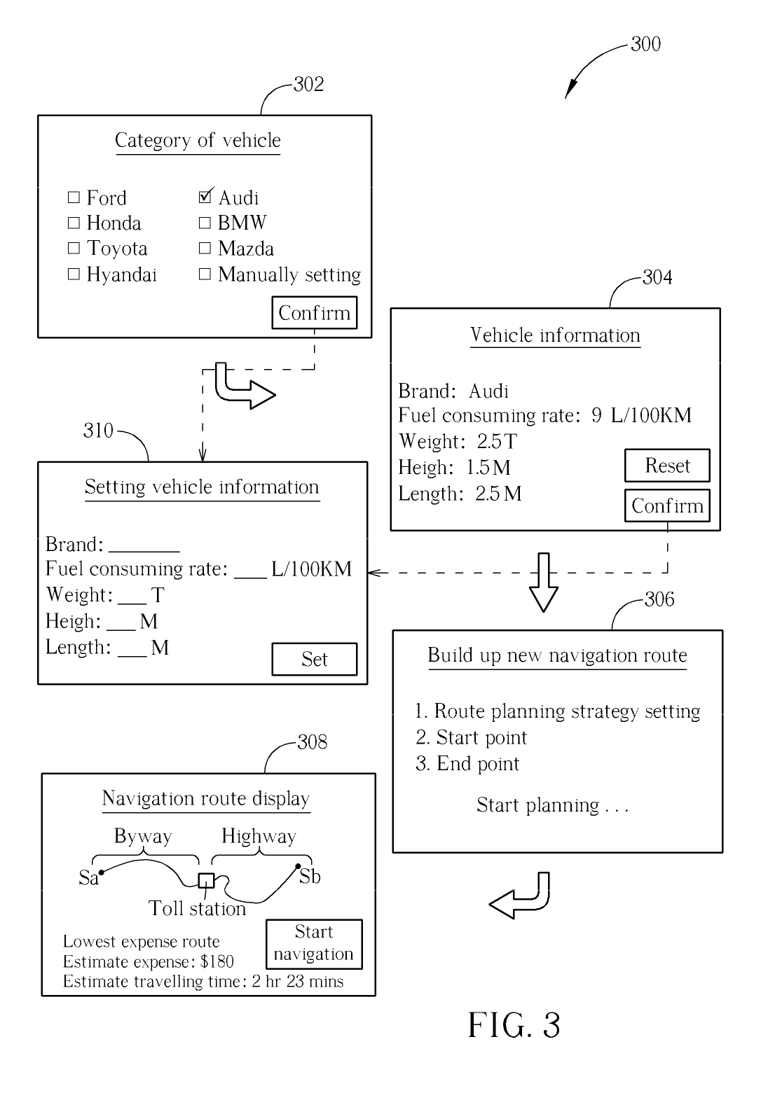

Please refer to FIG. 3. FIG. 3 is a diagram illustrating a process of planning the target navigation route Rt according to the navigation route determining method 100 of the present invention. Please note that, the process of planning the target navigation route Rt is displayed by a user interface of the navigation route determining apparatus 200 of the present invention. When the navigation route determining apparatus 200 is activated, the user interface displays a picture 302 to show a plurality of predetermined brands of vehicle, such as Ford, Honda, Toyota, Hyundai, Audi, BMW, and Mazda, for the user. When one of the categories is selected by the user, the navigation route determining apparatus 200 automatically loads the fuel consuming rate corresponding to the selected brand of the vehicle. Since the purpose of selecting one of the categories is to set the fuel consuming rate of the vehicle, there is another option for the user to manually input the information of the vehicle, such as the brand, the fuel consuming rate, the weight, the height, and the length of the vehicle if there is no such option displayed in the predetermined brands. Therefore, when the user selects the option of manual setting, a picture 310 pops up, in which the information of the vehicle can be inputted to the blank manually. Please note that, when a brand in the first picture 302 is selected, the user interface displays a picture 304 to show the information on the vehicle. If the user finds that the predetermined information on the vehicle is incorrect, a reset option can be selected to reset/correct the predetermined information of the vehicle. Therefore, when the reset option is selected, the picture 310 pops up for the user to correct the incorrect information of the vehicle. Then the user can just select the set option to save the information of the vehicle.

When the information of the vehicle is set, the user interface displays a picture 306, in which the route planning strategy, including the specific start point Sa and the specific end point Sb, can be set by the user to build up a new navigation route. Please refer to the above-mentioned step 108 of the navigation route determining method 100, if the lowest expense strategy (i.e., S1) is selected by the user, one of the embodiments of the user interface of the present invention is to display a picture 308 to show the target navigation route Rt from the specific start point Sa to the specific end point Sb, in which the route segment(s) of byway and highway and the toll station(s) are also displayed along the target navigation route Rt. In addition, according to the embodiment of the present invention, more detailed information about the target navigation route Rt can also be displayed in the picture 308, such as the estimated expense (i.e., C1) and the estimated traveling time. In this embodiment, the estimated expense (i.e., C1) is 180 dollars and the estimated traveling time is about 2 hours and 23 minutes. When the user accepts the information as displayed in the picture 308, the user can just select the start navigating option to start navigating.

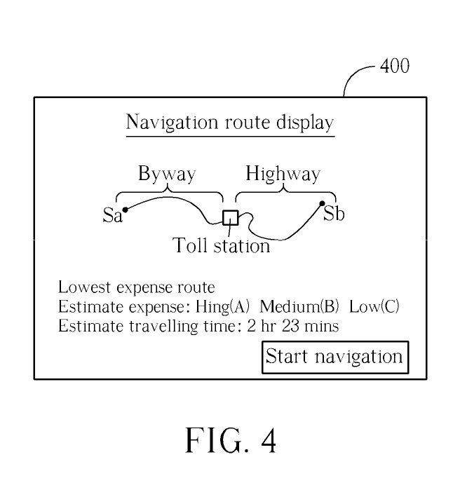

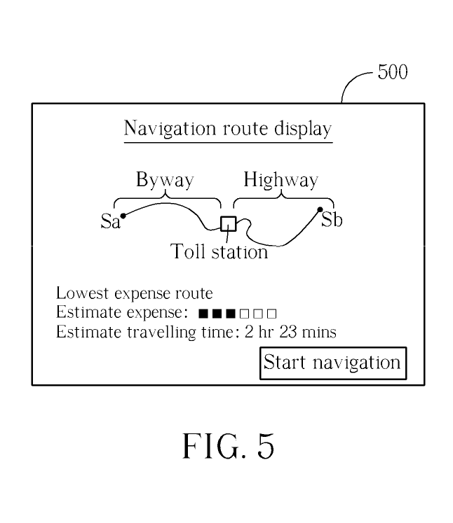

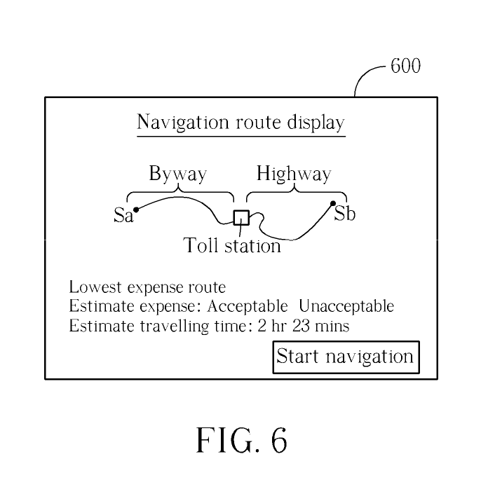

Please note that, the present invention does not limit way of displaying the picture 308. In another embodiment of the present invention, the estimated expense is categorized into three categories, which is high, medium and low, as shown in FIG. 4. FIG. 4 is a diagram illustrating the navigation route display 400 of the target navigation route Rt according to a second embodiment of the present invention. In another embodiment of the present invention, the estimated expense is represented by the filled grid(s) of a row of grids, in which the more grids filled, the higher the estimated expense, as shown in FIG. 5. FIG. 5 is a diagram illustrating the navigation route display 500 of the target navigation route Rt according to a third embodiment of the present invention. In another embodiment of the present invention, the estimated expense is categorized by two categories, which is the acceptable and the unacceptable, as shown in FIG. 6. FIG. 6 is a diagram illustrating the navigation route display 600 of the target navigation route Rt according to a fourth embodiment of the present invention.

Please refer to FIG. 2 again. The navigation route determining apparatus 200 comprises a navigation route planning module 202, a computing module 204, an interfacing module 206, and a detecting module 208. The interfacing module 206 comprises an interface unit 2062 and an expense display portion 2064. The interface unit 2062 comprises an input unit 20622 and an output unit 20644. The navigation route planning module 202 comprises a processing unit 2022, a register 2024, a data base 2026, a route guidance module 2028, a route planning module 2010, and a location system 2020. Please note that, the connectivity between the elements of the navigation route determining apparatus 200 is illustrated in FIG. 2, and is omitted here for brevity. The navigation route planning module 202 is utilized for performing the determination of the plurality of candidate navigation routes R1, R2, R3, R4 as mentioned in the navigation route determining method 100. The computing module 204 is coupled to the navigation route planning module 202 for performing the estimation of the plurality of expenses C1, C2, C3, C4 corresponding to the plurality of candidate navigation routes R1, R2, R3, R4, respectively. The interfacing module 206 is coupled to the navigation route planning module 202 to provide the user interface for the user to select one of the candidate navigation routes R1, R2, R3, R4 as the target navigation route according the plurality of expenses C1, C2, C3, C4. The detecting module 208 is coupled to the interfacing module 206 to automatically detect a category of the vehicle to set the fuel consuming rate of the vehicle. Please note that, the detecting module 208 is optional to the present invention. In another embodiment of the present invention, the detecting module 208 can be replaced by a setting module, which is coupled to the interfacing module 206, for manually selecting a category of vehicle from a plurality of predetermined vehicle categories to set the fuel consuming rate of the vehicle.

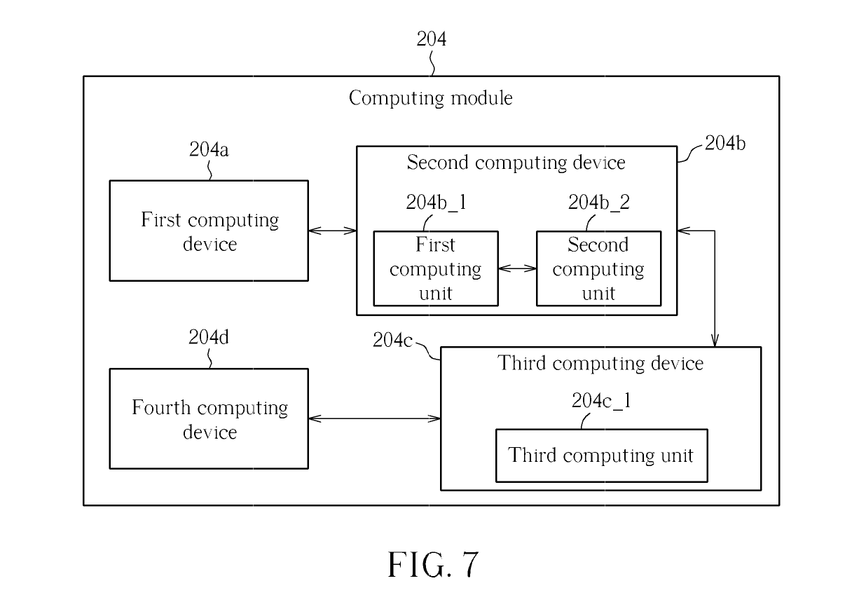

Please refer to FIG. 7. FIG. 7 is a diagram illustrating the computing module 204 of the navigation route determining apparatus 200 according to an embodiment of the present invention. The computing module 204 comprises a first computing device 204a, a second computing device 204b, a third computing device 204c, and a fourth computing device 204d. The second computing unit 204b comprises a first computing unit 204b_1 and a second computing unit 204b_2. The third computing unit 204c comprises a third computing unit 204c_1. The first computing device 204a is utilized for performing the determination of the distance of each candidate navigation route (i.e., R1, R2, R3, R4). The second computing device 204b is coupled to the first computing device 204a. The third computing device 204c is coupled to the second computing device 204b. The fourth computing device 204d is utilized to perform the determination of the total toll expense corresponding to each candidate navigation route. The first computing unit 204b_1 is utilized to perform the determination of the distance of each road segment, and the estimation of the fuel expense of each road segment according to the distance of the road segment, the fuel consuming rate, and a category of the road segment. The second computing unit 204b_2 is coupled to the first computing unit to perform the sum up operation of the fuel expenses of the road segments to determine the total fuel expense of the candidate navigation route. The third computing unit 204c_1 is utilized to perform the sum up operation of the total fuel expense and the total toll expense to determine the predetermined expense of the candidate navigation route.

Accordingly, the disclosed navigation route determining method 100 and the related navigation route determining apparatus 200 provides an efficient way for the user of the navigator to estimate the total expense to drive from the specific start point Sa to the specific end point Sb.

Those skilled in the art will readily observe that numerous modifications and alterations of the device and method may be made while retaining the teachings of the invention.

What is claimed is:

1. A navigation route determining method for planning a target navigation route from a specific start point to a specific end point, comprising:
determining a plurality of candidate navigation routes, wherein each of the candidate navigation routes is from the specific start point to the specific end point;
estimating a plurality of expenses corresponding to the plurality of candidate navigation routes, respectively; and
selecting one of the plurality of candidate navigation routes as the target navigation route according the plurality of expenses.

2. The navigation route determining method of claim 1, wherein determining the plurality of candidate navigation routes comprises:
utilizing a plurality of route planning strategies to determine the plurality of candidate navigation routes, respectively.

3. The navigation route determining method of claim 1, wherein estimating the plurality of expenses comprises:
referring to at least a fuel consuming rate of a vehicle to estimate the plurality of expenses.

4. The navigation route determining method of claim 3, wherein referring to at least the fuel consuming rate of the vehicle to estimate the plurality of expenses comprises:
for each candidate navigation route:
determining a distance of the candidate navigation route;
estimating a total fuel expense of the candidate navigation route according to at least the distance and the fuel consuming rate; and
determining a predetermined expense of the candidate navigation route according to at least the total fuel expense.

5. The navigation route determining method of claim 4, wherein the candidate navigation route comprises a plurality of road segments, and estimating the total fuel expense of the candidate navigation route according to at least the distance and the fuel consuming rate comprises:
for each road segment, determining a distance of the road segment, and estimating a fuel expense of the road segment according to at least the distance of the road segment, the fuel consuming rate, and a category of the road segment; and
summing up fuel expenses of the road segments to determine the total fuel expense of the candidate navigation route.

6. The navigation route determining method of claim 4, wherein referring to at least the fuel consuming rate of the vehicle to estimate the plurality of expenses further comprises:
for each candidate navigation route, determining a total toll expense corresponding to the candidate navigation route; and
determining the predetermined expense of the candidate navigation route according to at least the fuel expense comprises:
summing up the total fuel expense and the total toll expense to determine the predetermined expense of the candidate navigation route.

7. The navigation route determining method of claim 3, further comprising:
automatically detecting a category of the vehicle to set the fuel consuming rate of the vehicle.

8. The navigation route determining method of claim 3, further comprising:
manually selecting a category of the vehicle from a plurality of predetermined vehicle categories to set the fuel consuming rate of the vehicle.

9. A navigation route determining method for planning a target navigation route from a specific start point to a specific end point, comprising:
determining a fuel consuming rate of a vehicle; and
determining the target navigation route according to at least the fuel consuming rate.

10. The navigation route determining method of claim 9, wherein determining the target navigation route comprises:
determining the target navigation route according to a toll expense and a fuel expense, wherein the fuel expense is derived according to at least the fuel consuming rate.

11. A navigation route determining apparatus for planning a target navigation route from a specific start point to a specific end point, comprising:
a navigation route planning module, for determining a plurality of candidate navigation routes, wherein each of the candidate navigation routes is from the specific start point to the specific end point;
a computing module, coupled to the navigation route planning module, for estimating a plurality of expenses corresponding to the plurality of candidate navigation routes, respectively; and
an interfacing module, coupled to the computing module, for selecting one of the plurality of candidate navigation routes as the target navigation route according the plurality of expenses.

12. The navigation route determining apparatus of claim 11, wherein the navigation route planning module utilizes a plurality of route planning strategies to determine the plurality of candidate navigation routes, respectively.

13. The navigation route determining apparatus of claim 11, wherein the computing module further refers to at least a fuel consuming rate of a vehicle to estimate the plurality of expenses.

14. The navigation route determining apparatus of claim 13, wherein the computing module further comprises:
a first computing device, for determining a distance of each candidate navigation route;
a second computing device, coupled to the first computing device, for estimating a total fuel expense of each candidate navigation route according to at least the distance and the fuel consuming rate; and
a third computing device, coupled to the second computing device, for determining a predetermined expense of the candidate navigation route according to at least the total fuel expense.

15. The navigation route determining apparatus of claim 14, wherein the candidate navigation route comprises a plurality of road segments, and the second computing device comprises:
a first computing unit, for determining a distance of each road segment, and estimating a fuel expense of each road segment according to at least the distance of the road segment, the fuel consuming rate, and a category of the road segment; and
a second computing unit, coupled to the first computing unit, for summing up fuel expenses of the road segments to determine the total fuel expense of the candidate navigation route.

16. The navigation route determining apparatus of claim 14, wherein the computing module further comprises:
a fourth computing device, for determining a total toll expense corresponding to each candidate navigation route; and
the third computing device comprises:
a third computing unit, for summing up the total fuel expense and the total toll expense to determine the predetermined expense of the candidate navigation route.

17. The navigation route determining apparatus of claim 13, further comprising:
a detecting module, coupled to the interfacing module, for automatically detecting a category of the vehicle to set the fuel consuming rate of the vehicle.

18. The navigation route determining apparatus of claim 13, further comprising:
a setting module, coupled to the interfacing module, for manually selecting a category of the vehicle from a plurality of predetermined vehicle categories to set the fuel consuming rate of the vehicle.

19. A navigation route determining apparatus for planning a target navigation route from a specific start point to a specific end point, comprising:
a detecting module, for determining a fuel consuming rate of a vehicle; and
a navigation route planning module, coupled to the detecting module, for determining the target navigation route according to at least the fuel consuming rate.

20. The navigation route determining apparatus of claim 19, wherein the navigation route planning module comprises:
a navigation route planning unit, for determining the target navigation route according to a toll expense and a fuel expense, wherein the fuel expense is derived according to at least the fuel consuming rate.
